(19) United States
(12) Patent Application Publication
(10) Pub. No.: US 2021/0094058 A1
(43) Pub. Date: Apr. 1, 2021

(54) PAINTING SYSTEM

(71) Applicant: TOYOTA JIDOSHA KABUSHIKI KAISHA, Toyota-shi (JP)

(72) Inventors: Keiichi FUJIWARA, Toyota-shi (JP); Shinji Tani, Miyoshi-shi (JP); Akira Numasato, Nagoya-shi (JP); Kazuki Tanaka, Toyota-shi (JP)

(73) Assignee: TOYOTA JIDOSHA KABUSHIKI KAISHA, Toyota-shi (JP)

(21) Appl. No.: 16/904,630

(22) Filed: Jun. 18, 2020

(30) Foreign Application Priority Data
Sep. 27, 2019 (JP) 2019-176734

(51) Int. Cl. B05B 16/60; B05B 16/00; B05B 14/43; F24F 11/30

(52) U.S. Cl. CPC B05B 16/60; B05B 16/90; F24F 2110/10; F24F 11/30; B05B 14/43

(57) ABSTRACT

A plurality of painting zones is connected in series by a plurality of air exhaust ducts so as to allow air to flow through the painting zones. A paint mist in air having passed through a painting chamber of each painting zone is removed by a dry filter. Feedback control is performed on the temperature and the humidity of air in a second painting zone other than a third painting zone to which conditioned air from an air conditioner is supplied. Thus, it is possible to appropriately adjust the temperature and the humidity of each painting zone and avoid degradation of painting quality in each painting zone, while achieving downsizing of the entire system by not providing a recycling air conditioner on the route of an air flow passage.

### INCORPORATION BY REFERENCE

The disclosure of Japanese Patent Application No. 2019-176734 filed on Sep. 27, 2019 including the specification, drawings and abstract is incorporated herein by reference in its entirety.

### BACKGROUND

### 1. Technical Field

The present disclosure relates to a painting system that paints objects-to-be-painted, for example, the bodies of automobiles. More particularly, the present disclosure relates to improvement of a painting system that includes a plurality of painting zones and paints an object-to-be-painted in each painting zone.

### 2. Description of Related Art

A painting system disclosed in Japanese Patent Application Publication No. 2016-67998 (JP 2016-67998 A) is conventionally known as a painting system that paints objects-to-be-painted, such as the bodies of automobiles, by spraying a mist of paint onto the objects-to-be-painted. In the painting system of JP 2016-67998 A, a painting booth in which objects-to-be-painted are painted is divided into a first painting zone and a second painting zone. Air of which the temperature and the humidity have been adjusted by an air conditioner is supplied to the first painting zone, and an unapplied paint mist is exhausted from the first painting zone by an airflow (downflow). Then, air from which the unapplied paint mist has been removed by a mist remover provided on an exhaust side of the first painting zone is supplied to the second painting zone (to reuse the air). Thus, the conditioned air is effectively used to reduce the air conditioning cost.

### SUMMARY

To achieve good painting quality in a painting zone, the temperature and the humidity of the painting zone (the temperature and the humidity of air supplied to the painting zone) need to be appropriately adjusted. In the painting system of JP 2016-67998 A, air having undergone changes in the temperature and the humidity while passing through the first painting zone is supplied as is to the second painting zone, but the temperature and the humidity of the second painting zone are given no consideration, which makes it difficult to achieve good painting quality in the second painting zone. Achieving good painting quality in the second painting zone requires a recycling air conditioner that adjusts the temperature and the humidity of air exhausted from the first painting zone. However, such a recycling air conditioner would inevitably add to the size of the entire painting system.

Specifically, a painting booth of a common painting system is provided with a wet mist remover that causes contact between exhaust air (air exhausted) from a painting zone and water (gas-liquid contact) to thereby collect a paint mist contained in the exhaust air. In this case, the humidity of the exhaust air changes to near a saturation point while the exhaust air passes through the mist remover, so that, to reuse this exhaust air, it is necessary to adjust the temperature and the humidity thereof to the required temperature and humidity of air in a downstream-side painting booth. This process involves first dehumidifying air exhausted from an upstream-side painting booth and then reheating the air, which has been cooled by dehumidification, to raise the temperature of the air to a predetermined temperature. A recycling air conditioner used for such dehumidification and reheating is large. Moreover, if air of which the temperature has been adjusted tends to undergo a temperature rise while flowing through an air exhaust system, a device for cooling the air is also required. For these reasons, the configuration of JP 2016-67998 A cannot be realized without increasing the size of the entire painting system.

The present disclosure has been contrived in view of this, and an object of the disclosure is to provide a painting system that can achieve downsizing of the entire system.

Solutions adopted by the present disclosure to achieve the above object are premised on a painting system that includes a plurality of painting zones divided from one another and paints an object-to-be-painted by spraying a mist of paint onto the object-to-be-painted in each of the painting zones. This painting system includes an air conditioner, an air supply fan, a cascade air passage, a cascade fan, an air exhaust fan, a mist remover, and a control unit. The air conditioner takes in outside air and adjusts the temperature and the humidity of the outside air. The air supply fan supplies conditioned air that is the outside air of which the temperature and the humidity have been adjusted by the air conditioner to at least a specific fresh air-introduced painting zone among the painting zones. The cascade air passage connects the painting zones in series so as to allow air to flow through the painting zones. The cascade fan is provided in the cascade air passage and pumps air exhausted from a painting zone on an upstream side in an air flow direction to a painting zone on a downstream side in the air flow direction. The air exhaust fan exhausts air from a painting zone on the most downstream side in the air flow direction. The mist remover is of dry type and in each of the painting zones removes a paint mist in air having passed through a painting chamber in which the object-to-be-painted is located. The control unit performs feedback control on the temperature and the humidity of air in at least one painting zone other than the fresh air-introduced painting zone through temperature and humidity adjusting actions of the air conditioner.

According to these specifications, conditioned air generated by the air conditioner is supplied to at least the fresh air-introduced painting zone as the air supply fan operates. As air exhausted from the fresh air-introduced painting zone (air that contains an unapplied paint mist and has created a downflow in the fresh air-introduced painting zone) passes through the dry mist remover, the paint mist in the air is removed and this air is supplied to a downstream-side painting zone through the cascade air passage (to be reused). By thus effectively using air, it is possible to reduce the required amount of air blown from the air conditioner and thereby downsize the air conditioner and reduce the energy consumption rate. A paint mist in air exhausted from the downstream-side painting zone is also removed as this air passes through the dry mist remover. The air having been thus reused and passed through a plurality of painting zones is exhausted from the painting zone on the most downstream side in the air flow direction as the air exhaust fan operates. Since the mist remover that removes a paint mist in air exhausted from each painting zone is of dry type, the air does not undergo a temperature rise while passing through this mist remover. This means that there is no need for a device that dehumidifies air flowing through each painting zone (a recycling air conditioner for dehumidification).

In a situation where air is thus flowing through the painting zones, the temperature and the humidity of air in at least one painting zone other than the fresh air-introduced painting zone are under the feedback control of the control unit through the temperature and humidity adjusting actions of the air conditioner. Thus, the air in this painting zone (the painting zone under the feedback control) is maintained at an appropriate temperature and humidity. As a result, the painting zones located on the upstream side of the painting zone under the feedback control in the air flow direction (the painting zones including the fresh air-introduced painting zone) and the painting zones located on the downstream side of the painting zone under the feedback control in the air flow direction (when there are painting zones on the downstream side of the painting zone under the feedback control in the air flow direction) are each maintained at a reasonably appropriate temperature and humidity and do not significantly deviate from the required temperature and humidity. For example, due to the influence of heat received from the cascade fan and other factors, the temperature of an upstream-side painting zone is slightly lower than the temperature of the painting zone under the feedback control, and the temperature of a downstream-side painting zone is slightly higher than the temperature of the painting zone under the feedback control. Therefore, there is no need for a device that adjusts the temperature and the humidity of air flowing through the painting zones (recycling air conditioner).

Thus, these solutions make it possible to appropriately adjust the temperature and the humidity of each painting zone and avoid degradation of painting quality in each painting zone, while achieving downsizing of the entire system by not providing a recycling air conditioner on the route of the passage through which air flows (air flow passage).

The object-to-be-painted may be painted while moving sequentially through the painting zones, and the fresh air-introduced painting zone to which the conditioned air is supplied may be a painting zone that is located on the most downstream side of all the painting zones in a moving direction of the object-to-be-painted.

It is often the case that a painting zone located on the most downstream side in a moving direction of an object-to-be-painted in a painting system in which the object-to-be-painted is painted while moving sequentially through a plurality of painting zones (a painting system having a painting booth composed of a plurality of painting zones) is a check zone in which whether or not the object-to-be-painted has been appropriately painted is evaluated. Since a worker may enter this check zone to manually touch up the paintwork, it is preferable that this check zone be free of a solvent contained in a paint and other such substances. A solvent etc. exhausted from an upstream-side painting zone may flow into painting zones other than the fresh air-introduced painting zone that is the painting zone on the most upstream side in the air flow direction (the painting zone to which conditioned air from the air conditioner is supplied). In these solutions, therefore, the fresh air-introduced painting zone is set as the painting zone located on the most downstream side in the moving direction of the object-to-be-painted, so that a good environment (an environment free of a solvent etc.) can be provided in the painting zone that a worker may enter.

The painting system may include three or more painting zones, and in each of the painting zones a different level of painting quality of the object-to-be-painted may be required. The painting zone in which the temperature and the humidity of the air are under the feedback control of the control unit may be a painting zone in which the highest level of painting quality is required of all the painting zones.

As described above, to achieve good painting quality in a painting zone, the temperature and the humidity of the painting zone (the temperature and the humidity of air supplied to the painting zone) need to be appropriately adjusted. In particular, in a painting zone in which high painting quality is required, the temperature and the humidity need to be adjusted with high accuracy relative to a target temperature and humidity for achieving high painting quality. Therefore, the painting zone in which the highest painting quality is required of all the painting zones is set as the painting zone under the temperature and humidity feedback control, so that the temperature and the humidity of this painting zone can be adjusted with high accuracy to thereby achieve the required high painting quality. Since the painting quality required in other painting zones is relatively low, it suffices to maintain the environments in these painting zones at a reasonably appropriate temperature and humidity. As described above, the temperature of the painting zone located on the upstream side of the painting zone under the feedback control in the air flow direction is slightly lower than the temperature of the painting zone under the feedback control, and the temperature of the painting zone located on the downstream side of the painting zone under the feedback control in the air flow direction is slightly higher than the temperature of the painting zone under the feedback control. These temperature deviations are slight and within an allowable range for achieving the painting quality required in these painting zones. It is therefore possible to appropriately adjust the temperature and the humidity of each painting zone without providing a recycling air conditioner on the route of the air flow passage.

When the object-to-be-painted is to be painted while moving sequentially through the painting zones as described above, the painting zone in which the highest level of painting quality is required may be a painting zone that is located on the most downstream side in a moving direction of the object-to-be-painted except for the fresh air-introduced painting zone.

As described above, it is often the case that a painting zone located on the most downstream side in a moving direction of an object-to-be-painted in a painting system in which the object-to-be-painted is painted while moving sequentially through a plurality of painting zones is a check zone in which whether or not the object-to-be-painted has been appropriately painted is evaluated, and that a painting zone located on the most downstream side in the moving direction of the object-to-be-painted except for this check zone (the fresh air-introduced painting zone) is a painting zone in which a finish coating is applied to the object-to-be-painted (in the case of the body of an automobile, to exterior panels). Thus, the painting zone located on the most downstream side in the moving direction of the object-to-be-painted except for the fresh air-introduced painting zone is the painting zone in which the highest painting quality is required. Since this painting zone in which the highest painting quality is required is set as the painting zone under the feedback control (temperature and humidity feedback control), the temperature and the humidity of this painting zone can be adjusted with high accuracy relative to the target temperature and humidity in this painting zone to thereby achieve the required high painting quality.

An air supply passage may be connected to an air outlet side of the air conditioner, and a downstream-side part of the air supply passage may be branched into a plurality of branch passages. The painting system may be configured such that the conditioned air from the air conditioner is supplied to each of the painting zones through these branch passages.

In this configuration, air exhausted from an upstream-side painting zone and conditioned air generated by the air conditioner are mixed in each of the painting zones other than the fresh air-introduced painting zone, so that, compared with when only the air exhausted from the upstream-side painting zone is supplied, each of the painting zones (the painting zone located on the downstream side of the painting zone under the feedback control in the air flow direction and the painting zone located on the upstream side of the painting zone under the feedback control in the air flow direction) can be brought closer to an appropriate temperature and humidity. Specifically, supplying the conditioned air to the painting zone located on the downstream side of the painting zone under the feedback control in the air flow direction can keep the temperature of this downstream-side painting zone from rising and keep the relative humidity thereof from decreasing due to a temperature rise. Thus, this downstream-side painting zone can be kept from undergoing an excessive rise in the temperature or an excessive decrease in the humidity (relative humidity), and can be brought closer to an appropriate temperature and humidity. Moreover, supplying the conditioned air to the painting zone under the feedback control can decrease the temperature of this painting zone. Therefore, the temperature of the conditioned air generated by the air conditioner to adjust the temperature of the painting zone under the feedback control can be set to a higher temperature (compared with when the conditioned air is not supplied to the painting zone under the feedback control), so that the temperature of the painting zone located on the upstream side of the painting zone under the feedback control in the air flow direction can be kept from decreasing and the relative humidity thereof can be kept from rising due to a temperature decrease. Thus, this upstream-side painting zone can be kept from undergoing an excessive decrease in the temperature or an excessive rise in the humidity, and can be brought closer to an appropriate temperature and humidity.

The painting system may include: a conditioned air supply amount adjuster which is provided in the branch passage and of which the opening degree is changeable so as to adjust an amount of conditioned air supplied to each of the painting zones; an air exhaust amount adjuster of which the opening degree is changeable so as to adjust an amount of air released into the atmosphere out of air exhausted from each of the painting zones except for a painting zone on the most downstream side in the air flow direction; an air temperature detector that detects the temperature of air flowing between the cascade fan and a painting zone on the downstream side of the cascade fan in the air flow direction; and an opening degree control unit that determines the opening degrees of the conditioned air supply amount adjuster and the air exhaust amount adjuster according to the temperature of the air detected by the air temperature detector.

In this configuration, when the opening degree of the conditioned air supply amount adjuster is increased, the amount of conditioned air supplied to a painting zone increases, so that the temperature of air in this painting zone can be kept from rising. When the opening degree of the air exhaust amount adjuster is increased, the amount of air released into the atmosphere out of air exhausted from a painting zone increases, so that the temperature of air in a painting zone on the downstream side in the air flow direction can be kept from rising. Thus, the temperature of air in each painting zone can be adjusted according to the opening degree of each of the conditioned air supply amount adjuster and the air exhaust amount adjuster. Even in a situation where the temperature of air flowing through the cascade air passage varies as the amount of heat released from the cascade fan varies, it is possible to bring the temperature of air introduced (supplied) to a painting zone closer to an appropriate temperature by determining the opening degrees of the conditioned air supply amount adjuster and the air exhaust amount adjuster according to the temperature of air detected by the air temperature detector. As a result, high painting quality can be achieved.

The painting system may include an air blow amount adjuster that adjusts an amount of air blown by the air supply fan, and an air blow amount control unit that sends an air blow amount command signal to the air blow amount adjuster according to the opening degrees of the conditioned air supply amount adjuster and the air exhaust amount adjuster determined by the opening degree control unit.

The required amount of conditioned air supplied to each painting zone varies according to the opening degrees of the conditioned air supply amount adjuster and the air exhaust amount adjuster. These solutions make it possible to set the amount of conditioned air blown from the air conditioner to an appropriate air blow amount according to the opening degrees of the conditioned air supply amount adjuster and the air exhaust amount adjuster, so that the amount of conditioned air supplied to each painting zone is unlikely to fall short, and the temperature of each painting zone and the flow speed of the downflow in each painting zone can be adjusted to an appropriate temperature and speed.

In the present disclosure, the painting zones are connected in series by the cascade air passage so as to allow air to flow through the painting zones. A paint mist in air having passed through the painting chamber of each painting zone is removed by the dry mist remover. The feedback control is performed on the temperature and the humidity of air in one painting zone other than the fresh air-introduced painting zone to which conditioned air from the air conditioner is supplied. Thus, it is possible to appropriately adjust the temperature and the humidity of each painting zone and avoid degradation of painting quality in each painting zone, while achieving downsizing of the entire system by not providing a recycling air conditioner on the route of the air flow passage.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing a schematic configuration of a painting system according to a first embodiment;

FIG. 2 is a view showing a schematic configuration of a second painting booth;

FIG. 3 is a diagram showing a schematic configuration of a painting system according to a second embodiment; and

FIG. 4 is a diagram showing a schematic configuration of a painting system according to a third embodiment.

### DETAILED DESCRIPTION OF EMBODIMENTS

Embodiments of the present disclosure will be described below based on the drawings. These embodiments will be described based on a case where the present disclosure is applied to a painting system that paints the bodies of automobiles by spraying a mist paint onto the bodies by a plurality of painting robots. Further, these embodiments will be described based on a case where the present disclosure is applied to a painting system in which a painting booth is divided into three painting zones.

Generally, painting the body of an automobile involves sequentially applying a base coating, an intermediate coating, and a top coating. The base coating is a coating for rust prevention and applied by immersing the body in a paint bath holding a paint. The intermediate coating and the top coating are coatings applied by spraying a mist paint onto the body. The painting system according to the present disclosure can be applied to both of a painting system for applying an intermediate coating and a painting system for applying a top coating. In the following, a case where the present disclosure is applied to a painting system for applying a top coating will be described.

### First Embodiment

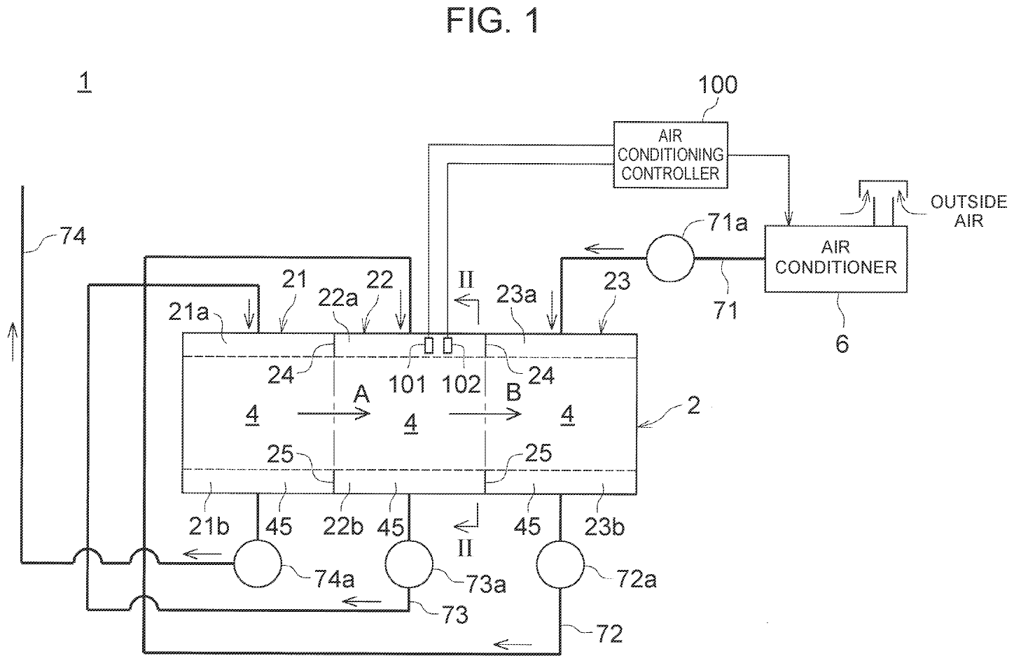

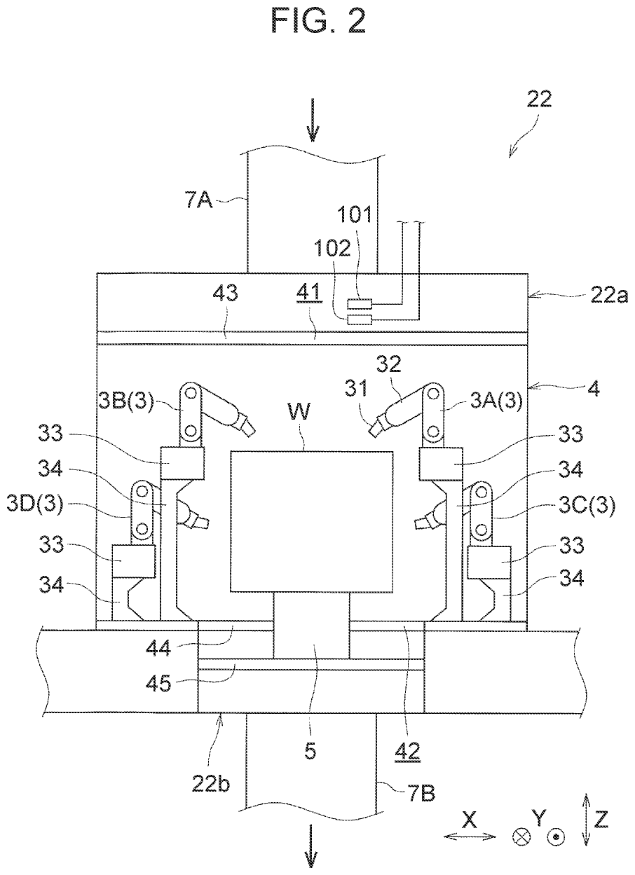

FIG. 1 is a diagram showing a schematic configuration of a painting system 1 according to a first embodiment. As shown in FIG. 1, a painting booth 2 of the painting system 1 according to this embodiment has three painting zones 21, 22, 23. A body W (see FIG. 2) of an automobile that is an object-to-be-painted is painted while being transferred sequentially through the three painting zones 21, 22, 23 (see arrows A and B in FIG. 1).

Specifically, in FIG. 1, the painting zone located on the leftmost side is a first painting zone 21; the painting zone located at the center is a second painting zone 22; and the painting zone located on the rightmost side is a third painting zone (the “fresh air-introduced painting zone” as termed in the present disclosure) 23.

The first painting zone 21 is a painting zone in which inner surfaces of doors (not shown) of the body W are painted. The second painting zone 22 is a painting zone in which exterior panels (exterior panels of the doors, an upper surface of a roof, etc.) of the body W are painted. As will be described later, a plurality of painting robots 3 (see FIG. 2) is installed in the first painting zone 21 and the second painting zone 22, and the body W is painted by these painting robots 3. The third painting zone 23 is a check zone in which whether or not the body W has been appropriately painted is evaluated (a painting zone for painting quality check). A worker may enter the third painting zone 23 to manually touch up the paintwork. In the third painting zone 23, therefore, no painting robots are installed and a painting gun (spray gun; not shown) for manual painting is provided.

Thus, the first to third painting zones 21, 22, 23 are coupled to one another in a horizontal direction to form the painting booth 2. In a painting process of the body W, the inner surfaces of the doors of the body W transferred to the first painting zone 21 are painted by the painting robots 3 installed in the first painting zone 21. Then, the body W is transferred to the second painting zone 22 (see arrow A in FIG. 1) and painted by the painting robots 3 installed in the second painting zone 22. Then, the body W is transferred to the third painting zone 23 (see arrow B in FIG. 1), where a worker evaluates whether or not the body W has been appropriately painted and manually touches up the paintwork as necessary. Thus, in the painting system 1 according to this embodiment, the second painting zone 22 corresponds to “the painting zone located on the most downstream side in the moving direction of the object-to-be-painted except for the fresh air-introduced painting zone” as termed in the present disclosure. Painting work in the first painting zone 21 and the second painting zone 22 may be performed with the body W being held stationary or being moved.

Schematic Configuration of Painting Zone

Here, a schematic configuration of the second painting zone 22 among the painting zones 21, 22, 23 will be described. FIG. 2 is a view showing the schematic configuration of the second painting zone 22 (a view of an inside of the second painting zone 22 as seen from the position corresponding to line II-II in FIG. 1).

As shown in FIG. 2, the second painting zone 22 includes the painting robots 3, a painting chamber 4 in which the painting robots 3 are installed, an air supply chamber 22a disposed above the painting chamber 4, a collection chamber 22b disposed under the painting chamber 4, and a transfer device 5 that transfers the body W. An X-direction, a Y-direction, and a Z-direction in FIG. 2 are a width direction, a length direction, and a height direction, respectively, of the second painting zone 22. The body W is transferred in the Y-direction by the transfer device 5.

The painting robot 3 includes a spray gun 31, a robot arm 32, and a pillar 34 on which a base 33 of the robot arm 32 is mounted. The pillar 34 stands upright on a floor of the painting chamber 4. In painting work by the painting robot 3, the robot arm 32 is activated so as to bring a tip of the spray gun 31 closer to a predetermined surface to be painted of the body W, and an atomized paint (paint mist) is applied (sprayed) from the spray gun 31 onto the body W. Painting in this embodiment is performed by an electrostatic atomization method. Most of the paint sprayed from the spray gun 31 toward the body W is applied to the body W, while an unapplied paint mist that remains without being applied to the body W is exhausted from the painting chamber 4 by an airflow (downflow) heading from the air supply chamber 22a toward the collection chamber 22b as will be described later.

In this embodiment, four painting robots 3 are installed in the painting chamber 4. Specifically, these are painting robots 3A to 3D that paint the body W from a right upper side, a left upper side, a right lower side, and a left lower side, respectively. The two painting robots 3A, 3B that paint the body W from an upper side are installed at substantially the same level and face each other in the width direction of the second painting zone 22. The two painting robots 3C, 3D that paint the body W from a lower side are installed at substantially the same level and face each other in the width direction of the second painting zone 22. The number of the painting robots 3 installed in the second painting zone 22 is not limited to four but set as appropriate. In the painting system 1 according to this embodiment, one body W at a time is transferred to each of the painting zones (the painting zones in which the painting robots 3 are installed) 21, 22 and the one body W is painted. When two or more bodies W at a time are transferred to and painted in each of the painting zones 21, 22, the number of the painting robots 3 to be installed is increased accordingly.

An introduction opening 41 through which air is introduced is formed in a ceiling of the painting chamber 4. An exhaust opening 42 through which air is exhausted is formed in the floor of the painting chamber 4. A filter 43 is provided in the introduction opening 41. A grid plate 44 is provided in the exhaust opening 42.

An air supply duct 7A is connected to the air supply chamber 22a and air is introduced (supplied) through the duct 7A. The air introduced into the air supply chamber 22a is supplied to the painting chamber 4 after the flow of the air is regulated in the air supply chamber 22a.

The collection chamber 22b is provided to collect a paint mist in air exhausted from the painting chamber 4. An air exhaust duct 7B is connected to the collection chamber 22b, and air is exhausted through the duct 7B. A filter 45 is provided inside the collection chamber 22b. The filter 45 is a thin dry filter (the “dry mist remover” as termed in the present disclosure), and is provided to remove a paint mist in air. Specifically, a filter that is produced by weaving a plurality of sheets of paper into a mesh and that has both air permeability and the ability to catch a paint mist can be used as the filter 45. However, the filter 45 is not limited to this example, and any filter can be used that does not use water like a conventional wet mist remover that causes contact between air and water.

The transfer device 5 is provided to transfer the body W into and out of the painting chamber 4.

While the schematic configuration of the second painting zone 22 has been described above, the first painting zone 21 has a similar configuration. As described above, the third painting zone 23 is a painting zone in which a worker manually touches up the paintwork and therefore no painting robots are installed and the spray gun for manual work is provided.

Air Flow Passage

Next, the configuration of an air flow passage that creates downflows (airflows heading from the air supply chambers 21a, 22a, 23a toward the collection chambers 21b, 22b, 23b) in the respective painting zones 21, 22, 23 will be described.

As shown in FIG. 1, the painting system 1 according to this embodiment includes an air conditioner 6 that generates conditioned air by taking in outside air and adjusting the temperature and the humidity of the outside air. The air conditioner 6 houses an air cooling device, an air heating device, a humidifying device, etc. inside a casing. The air cooling device cools outside air taken in. By being thus cooled, the outside air is dehumidified and the humidity thereof decreases. A chiller through which a coolant flows, a heat pump that uses a phase change of a cooling medium, or the like can be used as the air cooling device. The air heating device heats outside air taken in. An electric heater, a burner, a heat pump, or the like can be used as the air heating device. The humidifying device humidifies outside air taken in and air that has been dehumidified by the air cooling device. A shower nozzle that sprays water droplets or the like can be used as the humidifying device. A filter (not shown) is provided in an air intake opening of the air conditioner 6.

These air cooling device, air heating device, humidifying device, etc. are controlled by an air conditioning controller 100. Specifically, the air cooling device, air heating device, humidifying device, etc. are controlled in accordance with control signals output from the air conditioning controller 100, and thereby the temperature and the humidity of air ejected from the air conditioner 6 are adjusted. The air conditioning controller 100 is composed of a commonly known microcomputer including a CPU, ROM, RAM, etc. and of a peripheral circuit. The air conditioning controller 100 executes various calculations and processes based on an air conditioning control program stored in the ROM, and controls the operations of the various air conditioning control devices (the air cooling device, air heating device, humidifying device, etc.) of the air conditioner 6 that is connected to an output side of the air conditioning controller 100.

An air outlet side of the air conditioner 6 is connected to the air supply chamber 23a of the third painting zone 23 through an air supply duct 71 constituting an air supply passage. The air supply duct 71 is provided with an air supply fan 71a that pumps air from the air outlet side of the air conditioner 6 toward the air supply chamber 23a of the third painting zone 23.

The painting zones 21, 22, 23 are connected in series by a cascade air passage so as to allow air to flow through the painting zones 21, 22, 23. This will be specifically described below.

One end of a first air exhaust duct 72 is connected to the collection chamber 23b of the third painting zone 23, and the other end of the first air exhaust duct 72 is connected to the air supply chamber 22a of the second painting zone 22. The first air exhaust duct 72 is provided with a first cascade fan 72a that pumps air from the collection chamber 23b of the third painting zone 23 toward the air supply chamber 22a of the second painting zone 22.

One end of a second air exhaust duct 73 is connected to the collection chamber 22b of the second painting zone 22, and the other end of the second air exhaust duct 73 is connected to the air supply chamber 21a of the first painting zone 21. The second air exhaust duct 73 is provided with a second cascade fan 73a that pumps air from the collection chamber 22b of the second painting zone 22 toward the air supply chamber 21a of the first painting zone 21.

One end of a third air exhaust duct 74 is connected to the collection chamber 21b of the first painting zone 21, and the other end of the third air exhaust duct 74 is open to the atmosphere. The third air exhaust duct 74 is provided with an air exhaust fan 74a that pumps air from the collection chamber 21b of the first painting zone 21 toward the atmosphere. A filter that purifies air is provided on an air exhaust side of the third air exhaust duct 74. However, this filter is not necessary if releasing the air exhausted from the first painting zone 21 into the atmosphere poses no problem.

Thus, in the painting system 1 according to this embodiment, conditioned air from the air conditioner 6 flows through the third painting zone 23, the second painting zone 22, and the first painting zone 21 in this order. The first air exhaust duct 72 and the second air exhaust duct 73 constitute the “cascade air passage” as termed in the present disclosure. Compared with the configuration of a conventional common painting system in which conditioned air from an air conditioner is supplied to all the painting zones in parallel, this configuration can reduce the required amount of air blown from the air conditioner 6 and thereby downsize the air conditioner 6 and reduce the energy consumption rate.

Partition walls 24 are provided between adjacent ones of the air supply chambers 21a, 22a, 23a. Thus, airflows entering the air supply chambers 21a, 22a, 23a do not mix with one another. Similarly, partition walls 25 are provided between adjacent ones of the collection chambers 21b, 22b, 23b. Thus, airflows exhausted to the collection chambers 21b, 22b, 23b do not mix with one another.

One of the features of this embodiment is that only the second painting zone 22 among the painting zones 21, 22, 23 is provided with a temperature sensor 101 that detects the temperature of the second painting zone 22 and a humidity sensor 102 that detects the humidity thereof. Specifically, as shown also in FIG. 2, the sensors 101, 102 are disposed in the air supply chamber 22a of the second painting zone 22. Positions at which the sensors 101, 102 are disposed are set with consideration given to preventing a paint mist floating inside the painting chamber 4 of the second painting zone 22 from adhering to sensing parts of the sensors 101, 102 and thereby adversely affecting the sensing accuracy.

The temperature sensor 101 and the humidity sensor 102 are connected to the air conditioning controller 100 by signal lines. The air conditioning controller 100 outputs control signals to the air conditioner 6 according to information on the temperature of the second painting zone 22 detected by the temperature sensor 101 and information on the humidity of the second painting zone 22 detected by the humidity sensor 102, and the air cooling device, air heating device, humidifying device, etc. are controlled in accordance with these control signals.

Airflow During Painting Process

Next, an airflow during a painting process in the painting system 1 configured as has been described above will be described. In the painting process in the painting system 1, as described above, the inner surfaces of the doors of the body W transferred to the first painting zone 21 are painted by the painting robots 3 installed in the first painting zone 21. Then, the body W is transferred to the second painting zone 22 and painted by the painting robots 3 installed in the second painting zone 22. Then, the body W is transferred to the third painting zone 23, where a worker estimates whether or not the body W has been appropriately painted and manually touches up the paintwork as necessary.

The airflow during this painting process is as follows: The air conditioner 6 operates to take in outside air and generate conditioned air by adjusting the temperature and the humidity of the outside air. As the air supply fan 71a operates, this conditioned air is introduced from the air outlet side of the air conditioner 6 into the air supply chamber 23a of the third painting zone 23 through the air supply duct 71. The one end of the first air exhaust duct 72 is connected to the collection chamber 23b of the third painting zone 23, and the first air exhaust duct 72 is provided with the first cascade fan 72a. As the first cascade fan 72a operates, an airflow (downflow) heading from the air supply chamber 23a toward the collection chamber 23b is created in the third painting zone 23. When a worker manually touches up the paintwork, an unapplied paint mist generated in the third painting zone 23 is introduced into the collection chamber 23b by this downflow and removed by the dry filter 45 provided in the collection chamber 23b. The air from which the paint mist has been removed is exhausted from the third painting zone 23 to the first air exhaust duct 72.

As the first cascade fan 72a operates, the air exhausted to the first air exhaust duct 72 is introduced into the air supply chamber 22a of the second painting zone 22. The one end of the second air exhaust duct 73 is connected to the collection chamber 22b of the second painting zone 22, and the second air exhaust duct 73 is provided with the second cascade fan 73a. As the second cascade fan 73a operates, an airflow (downflow) heading from the air supply chamber 22a toward the collection chamber 22b is created also in the second painting zone 22. An unapplied paint mist generated in the second painting zone 22 is introduced into the collection chamber 22b by this downflow and removed by the dry filter 45 provided in the collection chamber 22b. The air from which the paint mist has been removed is exhausted from the second painting zone 22 to the second air exhaust duct 73.

As the second cascade fan 73a operates, the air exhausted to the second air exhaust duct 73 is introduced into the air supply chamber 21a of the first painting zone 21. The one end of the third air exhaust duct 74 is connected to the collection chamber 21b of the first painting zone 21, and the third air exhaust duct 74 is provided with the air exhaust fan 74a. As the air exhaust fan 74a operates, an airflow (downflow) heading from the air supply chamber 21a toward the collection chamber 21b is created also in the first painting zone 21. An unapplied paint mist generated in the first painting zone 21 is introduced into the collection chamber 21b by this downflow and removed by the dry filter 45 provided in the collection chamber 21b. The air from which the paint mist has been removed is released from the first painting zone 21 into the atmosphere through the third air exhaust duct 74.

The temperature of the second painting zone 22 (the temperature of the air supply chamber 22a of the second painting zone 22) is detected by the temperature sensor 101, and the humidity of the second painting zone 22 (the humidity of the air supply chamber 22a of the second painting zone 22) is detected by the humidity sensor 102. Information on the detected temperature and information on the detected humidity are sent to the air conditioning controller 100, and the air conditioner 6 is controlled through control signals output from the air conditioning controller 100. The control over the air conditioner 6 is feedback control that adjusts the temperature and the humidity of the second painting zone 22 to a preset target temperature and humidity. Specifically, this feedback control is performed such that the temperature and the humidity of air sent from the air conditioner 6 and introduced into the air supply chamber 22a of the second painting zone 22 through the air supply duct 71, the third painting zone 23, and the first air exhaust duct 72 meet the target temperature and humidity. The temperature and the humidity of outside air taken in by the air conditioner 6 vary as the time passes in the painting process, but as the feedback control is performed, the temperature and the humidity of the air introduced into the air supply chamber 22a of the second painting zone 22 can be adjusted to the target temperature and humidity, regardless of these variations in the temperature and the humidity of the outside air. The preset target temperature and humidity are determined in advance as a temperature and a humidity to achieve good painting quality in the second painting zone 22. For example, the target temperature is 23° C. and the target humidity is 75%, although these vary with the season. The target temperature and humidity are not limited to these values but set as appropriate according to the type of paint and the season.

In some cases, a downflow with a different flow speed is required in each of the painting zones 21, 22, 23. For example, the required flow speed differs according to the amount of unapplied paint mist generated in each of the painting zones 21, 22, 23. Generally, a higher flow speed is required in a painting zone in which a larger amount of unapplied paint mist is likely to be generated. The flow speed can be changed, for example, by adjusting the rotation speeds of the fans 72a, 73a, 74a.

As has been described above, in this embodiment, conditioned air generated by the air conditioner 6 flows through the third painting zone 23, the second painting zone 22, and the first painting zone 21 in series in this order. By thus effectively using air, it is possible to reduce the required amount of air blown from the air conditioner 6 and thereby downsize the air conditioner 6 and reduce the energy consumption rate.

Since a paint mist in air exhausted from each of the painting zones 21, 22, 23 is removed by the dry filter 45, the air does not undergo a humidity rise while passing through the filter 45. This means that there is no need for a device that dehumidifies air flowing through the painting zones 21, 22, 23 (a recycling air conditioner for dehumidification). The temperature and the humidity of air in the second painting zone 22 are under the feedback control of the air conditioning controller 100 through the temperature and humidity adjusting actions of the air conditioner 6. Thus, the air in the second painting zone 22 is maintained at an appropriate temperature and humidity. As a result, the third painting zone 23 located on the upstream side of the second painting zone 22 in the air flow direction and the first painting zone 21 located on the downstream side of the second painting zone 22 in the air flow direction are each maintained at a reasonably appropriate temperature and humidity and do not significantly deviate from the required temperature and humidity. For example, the temperature of the third painting zone 23 is slightly lower than the temperature of the second painting zone 22, and the temperature of the first painting zone 21 is slightly higher than the temperature of the second painting zone 22. Therefore, there is no need for a device that adjusts the temperature and the humidity of air flowing through the painting zones 21, 22, 23 (recycling air conditioner). Thus, in this embodiment, it is possible to appropriately adjust the temperature and the humidity of each of the painting zones 21, 22, 23 and avoid degradation of painting quality in each of the painting zones 21, 22, 23, while achieving downsizing of the entire system by not providing a recycling air conditioner on the route of the air flow passage.

In this embodiment, conditioned air from the air conditioner 6 is supplied to the third painting zone 23 located on the most downstream side in the moving direction of the body W. As described above, a worker may enter the third painting zone 23 to manually touch up the paintwork. It is therefore preferable that the third painting zone 23 be free of a solvent contained in a paint and other such substances. In this embodiment, the painting zone to which conditioned air from the air conditioner 6 is supplied is set as the third painting zone 23, so that a good environment (an environment free of a solvent etc.) can be provided in the painting zone that a worker may enter.

As described above, the second painting zone 22 is a painting zone in which the exterior panels of the body W are painted and in which the highest painting quality is required of all the painting zones 21, 22, 23. In this embodiment, the temperature sensor 101 and the humidity sensor 102 are provided in the second painting zone 22 in which the highest painting quality is required, and the feedback control is performed to adjust the temperature and the humidity of the second painting zone 22 to the preset target temperature and humidity. Thus, the temperature and the humidity of the second painting zone 22 can be adjusted with high accuracy to thereby achieve the required high painting quality. Since the painting quality required in the other painting zones (the first painting zone 21 and the third painting zone 23) is relatively low, it suffices to maintain the environments in these painting zones at a reasonably appropriate temperature and humidity. As described above, the temperature of the third painting zone 23 located on the upstream side of the second painting zone 22 in the air flow direction is slightly lower than the temperature of the second painting zone 22, and the temperature of the first painting zone 21 located on the downstream side of the second painting zone 22 in the air flow direction is slightly higher than the temperature of the second painting zone 22. These temperature deviations are slight and within an allowable range for achieving the painting quality required in the first painting zone 21 and the third painting zone 23. It is therefore possible to appropriately adjust the temperature and the humidity of each of the painting zones 21, 22, 23 without providing a recycling air conditioner on the route of the air flow passage.

### Second Embodiment

Next, a second embodiment will be described. This embodiment is different from the first embodiment in the configuration of the air flow passage. The other configurations and the actions in the painting process in this embodiment are the same as those in the first embodiment, and therefore only differences from the first embodiment in the configuration of the air flow passage and the airflow during the painting process will be described here.

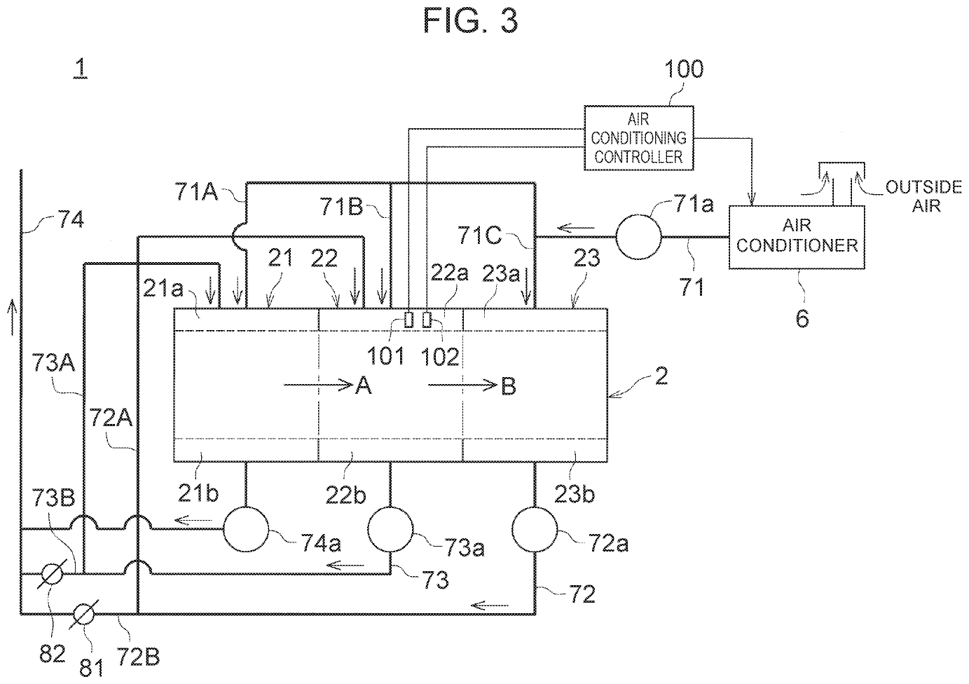

FIG. 3 is a diagram showing a schematic configuration of the painting system 1 according to this embodiment. Those members of FIG. 3 that are the same as the constituent members of the painting system 1 described in the first embodiment and shown in FIG. 1 will be denoted by the same reference signs and the description thereof will be omitted.

As shown in FIG. 3, in the painting system 1 according to this embodiment, a downstream-side part of the air supply duct 71 is branched into a first air supply duct 71A, a second air supply duct 71B, and a third air supply duct 71C. The air supply ducts 71A, 71B, 71C constitute the “branch passages” as termed in the present disclosure.

The first air supply duct 71A is connected to the air supply chamber 21a of the first painting zone 21. Thus, air exhausted from the second painting zone 22 to the second air exhaust duct 73 and conditioned air that is part of the conditioned air generated by the air conditioner 6 and that has passed through the first air supply duct 71A are introduced into the air supply chamber 21a of the first painting zone 21.

The second air supply duct 71B is connected to the air supply chamber 22a of the second painting zone 22. Thus, air exhausted from the third painting zone 23 to the first air exhaust duct 72 and conditioned air that is part of the conditioned air generated by the air conditioner 6 and that has passed through the second air supply duct 71B are introduced into the air supply chamber 22a of the second painting zone 22.

The third air supply duct 71C is connected to the air supply chamber 23a of the third painting zone 23. Thus, part of the conditioned air generated by the air conditioner 6 (conditioned air that does not flow into the first air supply duct 71A and the second air supply duct 71B) is introduced into the air supply chamber 23a of the third painting zone 23 through the third air supply duct 71C.

Further, a downstream-side part of the first air exhaust duct 72 is branched into a returning first air exhaust duct 72A and an exhausting first air exhaust duct 72B. The returning first air exhaust duct 72A is connected to the air supply chamber 22a of the second painting zone 22. The exhausting first air exhaust duct 72B is connected to the third air exhaust duct 74. The exhausting first air exhaust duct 72B is provided with a first air conditioning damper (air blow amount adjusting damper) 81 of which the opening degree is adjustable, and the flow rate of air in the third air exhaust duct 74 can be changed according to the opening degree of the first air conditioning damper 81. Specifically, the amount of air introduced into the air supply chamber 22a of the second painting zone 22 through the returning first air exhaust duct 72A and the amount of air released from the third air exhaust duct 74 through the exhausting first air exhaust duct 72B can be changed according to the opening degree of the first air conditioning damper 81.

Similarly, a downstream-side part of the second air exhaust duct 73 is branched into a returning second air exhaust duct 73A and an exhausting second air exhaust duct 73B. The returning second air exhaust duct 73A is connected to the air supply chamber 21a of the first painting zone 21. The exhausting second air exhaust duct 73B is connected to the third air exhaust duct 74. The exhausting second air exhaust duct 73B is provided with a second air conditioning damper 82 of which the opening degree is adjustable, and the flow rate of air in the third air exhaust duct 74 can be changed according to the opening degree of the second air conditioning damper 82. Specifically, the amount of air introduced into the air supply chamber 21a of the first painting zone 21 through the returning second air exhaust duct 73A and the amount of air released from the third air exhaust duct 74 through the exhausting second air exhaust duct 73B can be changed according to the opening degree of the second air conditioning damper 82.

In this embodiment, the air mixing ratio in the first painting zone 21, the air mixing ratio in the second painting zone 22, and the amount of conditioned air introduced into the third painting zone 23 are adjusted through the settings of the opening degrees of the air conditioning dampers 81, 82. The opening degrees of the air conditioning dampers 81, 82 are determined through experiment or simulation such that the temperatures of the painting zones 21, 22, 23 substantially match the target temperatures required in the respective painting zones 21, 22, 23, and are fixed at these determined opening degrees.

Generally, the temperatures of the painting zones 21, 22, 23 are such that the temperature of the second painting zone 22 is higher than the temperature of the third painting zone 23 and that the temperature of the first painting zone 21 is higher than the temperature of the second painting zone 22. This is attributable to heat that air receives while passing through the painting zones 21, 22, heat that air receives from the cascade fans 72a, 73a, and other factors. The amount of moisture in each of the painting zones 21, 22, 23 is determined by a dehumidifying action and a humidifying action in the air conditioner 6, and is substantially the same in these painting zones. Therefore, a painting zone at a higher temperature has a lower relative humidity, and a painting zone at a lower temperature has a higher relative humidity.

Under these conditions, in this embodiment, air exhausted from an upstream-side painting zone (the third painting zone 23 or the second painting zone 22) and conditioned air generated by the air conditioner 6 mix together in the first painting zone 21 and the second painting zone 22, so that, compared with when only the air exhausted from the upstream-side painting zone is supplied, each of the painting zones (the first painting zone 21 and the third painting zone 23) can be brought closer to an appropriate temperature and humidity. Specifically, supplying the conditioned air to the first painting zone 21 located on the downstream side in the air flow direction of the second painting zone 22 that is the painting zone under the feedback control can keep the temperature of the first painting zone 21 from rising and keep the relative humidity thereof from decreasing due to a temperature rise. Thus, the first painting zone 21 can be kept from undergoing an excessive rise in the temperature or an excessive decrease in the humidity, and can be brought closer to an appropriate temperature and humidity. Moreover, supplying the conditioned air to the second painting zone (the painting zone under the feedback control) 22 can decrease the temperature of the second painting zone 22. Therefore, the temperature of the conditioned air generated by the air conditioner 6 to adjust the temperature of the second painting zone 22 to an appropriate temperature can be set to a higher temperature (compared with when the conditioned air is not supplied to the second painting zone 22), so that the temperature of the third painting zone 23 located on the upstream side of the second painting zone 22 in the air flow direction can be kept from decreasing, and the relative humidity thereof can be kept from rising due to a temperature decrease. Thus, the third painting zone 23 can be kept from undergoing an excessive decrease in the temperature or an excessive rise in the humidity, and can be brought closer to an appropriate temperature and humidity.

Thus, in this embodiment, conditioned air is introduced also into the first painting zone 21 and the second painting zone 22 to achieve good painting quality in each of the painting zones 21, 22, 23.

### Third Embodiment

Next, a third embodiment will be described. This embodiment is different from the second embodiment in the configuration of the air flow passage and the control over the airflow. The other configurations and the actions in the painting process in this embodiment are the same as those in the above embodiments, and therefore only differences from the above embodiments in the configuration of the air flow passage and the control over the airflow will be described here.

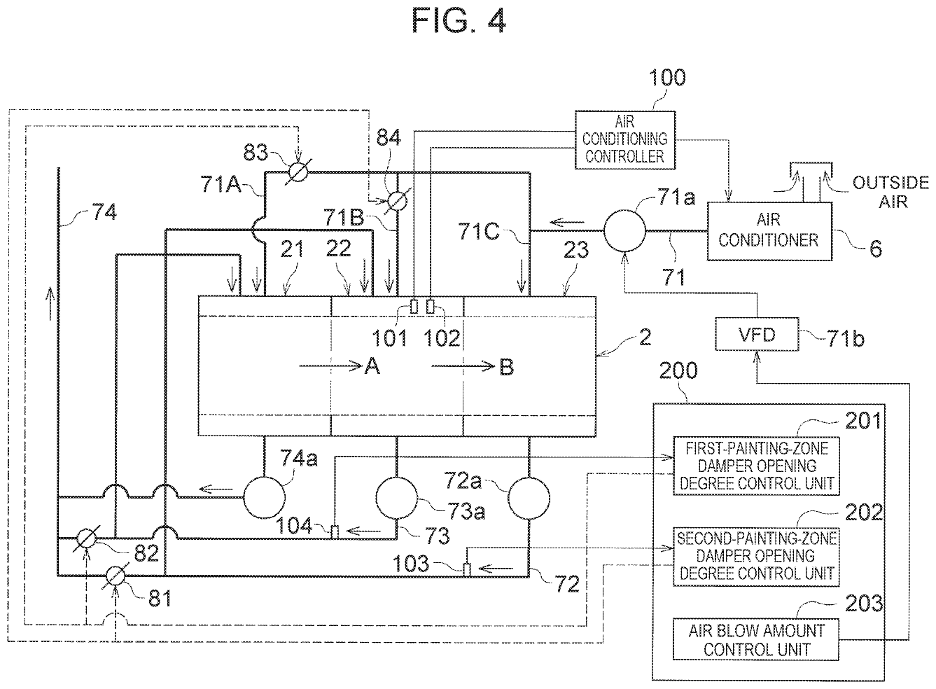

FIG. 4 is a diagram showing a schematic configuration of the painting system 1 according to this embodiment. Those members in FIG. 4 that are the same as the constituent members of the painting system 1 described in the above embodiments and shown in FIG. 1 and FIG. 3 will be denoted by the same reference signs and the description thereof will be omitted.

As shown in FIG. 4, the first air supply duct 71A is provided with a third air conditioning damper 83 of which the opening degree is adjustable, and the flow rate of conditioned air in the first air supply duct 71A can be changed according to the opening degree of the third air conditioning damper 83. Specifically, the mixing ratio of air introduced into the air supply chamber 21a of the first painting zone 21 (the mixing ratio of air exhausted from the second painting zone 22 and conditioned air from the air conditioner 6) can be changed according to the opening degree of the third air conditioning damper 83 and the opening degree of the second air conditioning damper 82.

Similarly, the second air supply duct 71B is provide with a fourth air conditioning damper 84 of which the opening degree is adjustable, and the flow rate of conditioned air in the second air supply duct 71B can be changed according to the opening degree of the fourth air conditioning damper 84. Specifically, the mixing ratio of air introduced into the air supply chamber 22a of the second painting zone 22 (the mixing ratio of air exhausted from the third painting zone 23 and conditioned air from the air conditioner 6) can be changed according to the opening degree of the fourth air conditioning damper 84 and the opening degree of the first air conditioning damper 81.

Thus, the third air conditioning damper 83 and the fourth air conditioning damper 84 correspond to the “conditioned air supply amount adjuster” (the conditioned air supply amount adjuster of which the opening degree is changeable so as to adjust the amount of conditioned air supplied to each of the painting zones) as termed in the present disclosure, and the first air conditioning damper 81 and the second air conditioning damper 82 correspond to the “air exhaust amount adjuster” (the air exhaust amount adjuster of which the opening degree is changeable so as to adjust the amount of air released into the atmosphere out of air exhausted from each of the painting zones except for the painting zone on the most downstream side in the air flow direction) as termed in the present disclosure.

Further, a first exhaust air temperature sensor (air temperature detector) 103 that detects the temperature of air flowing through the first air exhaust duct 72 (air having been exhausted from the third painting zone 23 and passed through the first cascade fan 72a) is mounted on the first air exhaust duct 72. A second exhaust air temperature sensor (air temperature detector) 104 that detects the temperature of air flowing through the second air exhaust duct 73 (air having been exhausted from the second painting zone 22 and passed through the second cascade fan 73a) is mounted on the second air exhaust duct 73.

The painting system 1 according to this embodiment includes an air controller 200 that controls the opening degrees of the air conditioning dampers 81, 82, 83, 84 and controls an inverter device (air blow amount adjuster) 71b that adjusts the rotation speed of the air supply fan 71a. As with the air conditioning controller 100, the air controller 200 is composed of a commonly known microcomputer including a CPU, ROM, RAM, etc. and of a peripheral circuit. The air controller 200 executes various calculations and processes based on a control program stored in the ROM, and controls the air conditioning dampers 81, 82, 83, 84 and the inverter device 71b that are connected to an output side of the air controller 200.

The air controller 200 includes a first-painting-zone damper opening degree control unit 201, a second-painting-zone damper opening degree control unit 202, and an air blow amount control unit 203.

The first-painting-zone damper opening degree control unit 201 receives an output from the second exhaust air temperature sensor 104 and controls the opening degrees of the second air conditioning damper 82 and the third air conditioning damper 83 based on the output. The first-painting-zone damper opening degree control unit 201 stores a map (matrix) associating an output (temperature information) from the second exhaust air temperature sensor 104 and the opening degrees of the second air conditioning damper 82 and the third air conditioning damper 83 with each other. In accordance with this map, the first-painting-zone damper opening degree control unit 201 determines the opening degrees of the second air conditioning damper 82 and the third air conditioning damper 83 according to an output from the second exhaust air temperature sensor 104, and sends opening degree command signals to the second air conditioning damper 82 and the third air conditioning damper 83.

The map stored in the first-painting-zone damper opening degree control unit 201 is such that, when the detected air temperature is high based on the temperature information output from the second exhaust air temperature sensor 104, the first-painting-zone damper opening degree control unit 201 performs control so as to increase the opening degree of the second air conditioning damper 82 (increase the amount of air released to the third air exhaust duct 74 out of air exhausted from the second painting zone 22) and increase the opening degree of the third air conditioning damper 83 (increase the amount of conditioned air introduced from the air conditioner 6), to thereby keep the temperature of the first painting zone 21 from rising and bring the first painting zone 21 closer to the required temperature. Thus, even in a situation where the temperature of air flowing through the second air exhaust duct 73 varies as the amount of heat released from the second cascade fan 73a varies, the temperature of air introduced into the first painting zone 21 can be brought closer to the required temperature of the first painting zone 21. The specific opening degrees of the dampers 82, 83 according to the detected air temperature are determined through experiment or simulation.

The second-painting-zone damper opening degree control unit 202 receives an output from the first exhaust air temperature sensor 103, and controls the opening degrees of the first air conditioning damper 81 and the fourth air conditioning damper 84 based on the output. The second-painting-zone damper opening degree control unit 202 stores a map associating the output (temperature information) from the first exhaust air temperature sensor 103 and the opening degrees of the first air conditioning damper 81 and the fourth air conditioning damper 84 with each other. In accordance with this map, the second-painting-zone damper opening degree control unit 202 determines the opening degrees of the first air conditioning damper 81 and the fourth air conditioning damper 84 according to an output from the first exhaust air temperature sensor 103, and sends opening degree command signals to the first air conditioning damper 81 and the fourth air conditioning damper 84.

The map stored in the second-painting-zone damper opening degree control unit 202 is such that, when the detected air temperature is high based on the temperature information output from the first exhaust air temperature sensor 103, the second-painting-zone damper opening degree control unit 202 performs control so as to increase the opening degree of the first air conditioning damper 81 (increase the amount of air released to the third air exhaust duct 74 out of air exhausted from the third painting zone 23) and increase the opening degree of the fourth air conditioning damper 84 (increase the amount of conditioned air introduced from the air conditioner 6), to thereby keep the temperature of the second painting zone 22 from rising and bring the second painting zone 22 closer to the required temperature. Thus, even in a situation where the temperature of air flowing through the first air exhaust duct 72 varies as the amount of heat released from the first cascade fan 72a varies, the temperature of air introduced into the second painting zone 22 can be brought closer to the required temperature of the second painting zone 22. The specific opening degrees of the dampers 81, 84 according to the detected air temperature are determined through experiment or simulation.

The air blow amount control unit 203 receives information from the first-painting-zone damper opening degree control unit 201 (information on the opening degree commands to the second air conditioning damper 82 and the third air conditioning damper 83) and information from the second-painting-zone damper opening degree control unit 202 (information on the opening degree commands to the first air conditioning damper 81 and the fourth air conditioning damper 84), and sends a rotation speed command signal to the inverter device 71b such that the rotation speed of the air supply fan 71a is adjusted to the rotation speed according to these pieces of information. The air blow amount control unit 203 stores a map associating the opening degrees of the dampers and the rotation speed of the air supply fan 71a with each other. In accordance with this map, the air blow amount control unit 203 sends a rotation speed command signal to the inverter device 71b according to the opening degrees of the dampers to thereby adjust the rotation speed of the air supply fan 71a to a predetermined rotation speed.

The map stored in the air blow amount control unit 203 is such that, when the opening degrees of the dampers 81 to 84 are large, the air blow amount control unit 203 performs control so as to increase the rotation speed of the air supply fan 71a to thereby avoid a shortfall of the amount of conditioned air supplied to the painting zones 21, 22, 23. Thus, the temperature of each of the painting zones 21, 22, 23 and the flow speed of the downflow in each of the painting zones 21, 22, 23 can be adjusted to an appropriate temperature and speed. The specific rotation speed of the air supply fan 71a according to the opening degrees of the dampers 81 to 84 is determined through experiment or simulation.

The first-painting-zone damper opening degree control unit 201, the second-painting-zone damper opening degree control unit 202, and the air blow amount control unit 203 are realized by a control program stored in the ROM of the air controller 200.

As has been described above, in this embodiment, the amount of conditioned air blown from the air conditioner 6 can be set to an appropriate air blow amount according to the opening degrees of the dampers 81 to 84, so that the amount of conditioned air supplied to each of the painting zones 21, 22, 23 is unlikely to fall short, and the temperature of each of the painting zones 21, 22, 23 and the flow speed of the downflow in each of the painting zones 21, 22, 23 can be adjusted to an appropriate temperature and speed. Thus, good painting quality in each of the painting zones 21, 22, 23 can be achieved, and a paint mist can be quickly exhausted from each of the painting zones 21, 22, 23.

### Other Embodiments

The present disclosure is not limited to the above embodiments, and any modifications and applications that are included in the scope of claims and an equivalent scope are possible.

For example, in the above embodiments, the case where the present disclosure is applied to the painting system 1 that paints the bodies W of automobiles has been described. However, the present disclosure is not limited to this example, and can also be applied to a painting system that paints other parts (bumpers etc.) of automobiles or parts of objects other than automobiles.

In the above embodiments, the case where the present disclosure is applied to the painting system 1 in which the painting booth 2 is divided into three painting zones 21, 22, 23 has been described. However, the present disclosure is not limited to this example, and can also be applied to a painting system in which the painting booth is divided into two painting zones as well as to a painting system in which the painting booth is divided into four or more painting zones. In the case of a painting system in which the painting booth is divided into two painting zones, for example, the painting zone on the downstream side in the moving direction of the body W is the painting zone to which conditioned air from the air conditioner 6 is supplied, and the painting zone on the upstream side in the moving direction of the body W is the painting zone under the feedback control. In the case of a painting system in which the painting booth is divided into four or more painting zones, for example, the painting zone located on the most downstream side in the moving direction of the body W is the painting zone to which conditioned air from the air conditioner 6 is supplied, and the painting zone located on the most downstream side in the moving direction of the body W except for this painting zone is the painting zone under the feedback control.

In the above embodiments, only the second painting zone 22 among the painting zones 21, 22, 23 is provided with the temperature sensor 101 and the humidity sensor 102. However, the present disclosure is not limited to this example, and only one painting zone other than the second painting zone 22 may be provided with a temperature sensor and a humidity sensor, or more than one painting zone may be provided with a temperature sensor and a humidity sensor. In the case where only one painting zone other than the second painting zone 22 is provided with a temperature sensor and a humidity sensor, for example, when the first painting zone 21 is a painting zone in which the exterior panels of the body W are painted, only the first painting zone 21 is provided with a temperature sensor and a humidity sensor. In the case where more than one painting zone is provided with a temperature sensor and a humidity sensor, for example, not only the second painting zone 22 but also the first painting zone 21 is provided with a temperature sensor and a humidity sensor, and the sensors of the first painting zone 21 are used to determine whether there is any abnormality (an excessive rise in the temperature, an excessive rise in the humidity, etc.) in the first painting zone 21.

The present disclosure is applicable to a painting system that includes a plurality of painting zones and paints a vehicle body by spraying a mist paint onto the vehicle body in each of the painting zones.

What is claimed is:

1. A painting system that includes a plurality of painting zones divided from one another and paints an object-to-be-painted by spraying a mist of paint onto the object-to-be-painted in each of the painting zones, the painting system comprising:
an air conditioner that takes in outside air and adjusts temperature and humidity of the outside air;
an air supply fan that supplies conditioned air that is the outside air of which the temperature and the humidity have been adjusted by the air conditioner to at least a specific fresh air-introduced painting zone among the painting zones;
a cascade air passage that connects the painting zones in series so as to allow air to flow through the painting zones;
a cascade fan that is provided in the cascade air passage and pumps air exhausted from a painting zone on an upstream side in an air flow direction to a painting zone on a downstream side in the air flow direction;
an air exhaust fan that exhausts air from a painting zone on a most downstream side in the air flow direction;
a dry mist remover that, in each of the painting zones, removes a paint mist in air having passed through a painting chamber in which the object-to-be-painted is located; and
a control unit that performs feedback control on temperature and humidity of air in at least one painting zone other than the fresh air-introduced painting zone through temperature and humidity adjusting actions of the air conditioner.

2. The painting system according to claim 1, wherein:
the object-to-be-painted is painted while moving sequentially through the painting zones; and
the fresh air-introduced painting zone to which the conditioned air is supplied is a painting zone that is located on a most downstream side of all the painting zones in a moving direction of the object-to-be-painted.

3. The painting system according to claim 1, wherein:
the painting system includes three or more painting zones, and in each of the painting zones a different level of painting quality of the object-to-be-painted is required; and
the painting zone in which the temperature and the humidity of the air are under the feedback control of the control unit is a painting zone in which a highest level of painting quality is required of all the painting zones.

4. The painting system according to claim 3, wherein, when the object-to-be-painted is to be painted while moving sequentially through the painting zones, the painting zone in which the highest level of painting quality is required is a painting zone that is located on a most downstream side in a moving direction of the object-to-be-painted except for the fresh air-introduced painting zone.

5. The painting system according to claim 1, wherein:
an air supply passage is connected to an air outlet side of the air conditioner, and a downstream-side part of the air supply passage is branched into a plurality of branch passages; and
the painting system is configured such that the conditioned air from the air conditioner is supplied to each of the painting zones through these branch passages.

6. The painting system according to claim 5, comprising:
a conditioned air supply amount adjuster which is provided in the branch passage and of which an opening degree is changeable so as to adjust an amount of conditioned air supplied to each of the painting zones;
an air exhaust amount adjuster of which an opening degree is changeable so as to adjust an amount of air released into an atmosphere out of air exhausted from each of the painting zones except for a painting zone on a most downstream side in the air flow direction;
an air temperature detector that detects temperature of air flowing between the cascade fan and a painting zone on a downstream side of the cascade fan in the air flow direction; and
an opening degree control unit that determines the opening degrees of the conditioned air supply amount adjuster and the air exhaust amount adjuster according to the temperature of the air detected by the air temperature detector.

7. The painting system according to claim 6, comprising:
an air blow amount adjuster that adjusts an amount of air blown by the air supply fan; and
an air blow amount control unit that sends an air blow amount command signal to the air blow amount adjuster according to the opening degrees of the conditioned air supply amount adjuster and the air exhaust amount adjuster determined by the opening degree control unit.
